(19) United States
(12) Patent Application Publication
(10) Pub. No.: US 2019/0274479 A1
(43) Pub. Date: Sep. 12, 2019

(54) GRILL

(71) Applicant: REVOACE INC. LIMITED, Hong Kong (CN)

(72) Inventor: Kiosky Chung, Hong Kong (CN)

(21) Appl. No.: 15/919,181

(22) Filed: Mar. 12, 2018

(51) Int. Cl. A47J 37/07; F24B 13/04

(52) U.S. Cl. CPC A47J 37/0754; F24B 13/04; A47J 37/0786; A47J 37/0704

(57) ABSTRACT

A burner assembly includes external and internal tubes and front and rear panels. The internal tube is inserted in the external tube and includes front and rear open ends and two groups of orifices. The front panel is connected to a free end of the external tube and the front open end of the internal tube, thereby providing a first air chamber between the external and internal tubes. The rear panel is connected to the rear open end of the internal tube, thereby providing a second air chamber in the internal tube. The second air chamber is in communication with the front open end of the internal tube. The first air chamber is in communication with the second air chamber via the groups of orifices. The first group of orifices is located closer to the rear panel than the second group of orifices.

### BACKGROUND OF INVENTION

### 1. Field of Invention

The present invention relates to a grill and, more particularly, to a burner assembly for use in a grill.

### 2. Related Prior Art

As disclosed in U.S. Pat. No. 9,759,429, a grill includes a housing 10 that includes a heat distribution chamber 16. A burn chamber 22 is provided in heat distribution chamber 16. A pellet storage chamber 26 is provided out of heat distribution chamber 16. Burn chamber 22 in communication with pellet storage chamber 26 via a pellet feeder 28. An electrical igniter rod 41 is connected to burn chamber 22. A controller 40 is electrically connected to pellet feeder 28 and electrical igniter rod 41. Controller 40 is operable to actuate pellet feeder 28 to feed pellets into burn chamber 22 from pellet storage chamber 26 and actuate electrical igniter rod 41 to ignite the pellets in burn chamber 22.

The pellets are burnt and hence produce a lot of heat. The heat is spread in burn chamber 22 and the transferred to a cooking grid 18, thereby heating and cooking food on cooking grid 18. However, while some pellets are burnt in burn chamber 22, there are some other pellets in pellet feeder 28. The pellets in pellet feeder 28 are heated and dried by the heat so that some other pellets might be burnt in pellet storage chamber 26.

Moreover, controller 40 is electrically connected to pellet feeder 28 and electrical igniter rod 41 via wires. The wires are wrapped in plastic or rubber sheaths. The plastic or rubber sheaths deteriorate, age and rupture for being heated so that there are risks of leakage of electricity.

Referring to FIGS. 12 and 13 of US Patent Application Publication No. 2017/0176018, intended to improve the grills disclosed in U.S. Pat. Nos. 4,823,684 and 5,299,421, a grill is provided with an extended DC igniter 1270 and a heating element 1030 inserted deep into a combustion region 1275. Heating element 1030 is intended to contact a relatively large ament of wood pellets 1245 to expedite the burning of wood pellets 1245.

However, there is nothing to keep a pellet-storing region from the heat produced by the burning of wood pellets. Pellets might be heated and burned in the pellet-storing region. Hence, the grill might be burnt and damaged.

The present invention is therefore intended to obviate or at least alleviate the problems encountered in prior art.

### SUMMARY OF INVENTION

It is the primary objective of the present invention to provide a grill with a safe and efficient burner assembly.

To achieve the foregoing objective, the burner assembly includes external and internal tubes and front and rear panels. The internal tube is inserted in the external tube and includes front and rear open ends and two groups of orifices. The front panel is connected to a free end of the external tube and the front open end of the internal tube, thereby providing a first air chamber between the external and internal tubes. The rear panel is connected to the rear open end of the internal tube, thereby providing a second air chamber in the internal tube. The second air chamber is in communication with the front open end of the internal tube. The first air chamber is in communication with the second air chamber via the groups of orifices. The first group of orifices is located closer to the rear panel than the second group of orifices.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is an exploded view of a grill according to the preferred embodiment of the present invention;

FIG. 2 is a cut-away view of the grill shown in FIG. 1;

FIG. 3 is a side view of a burner assembly, a blower and a feeder of the grill shown in FIG. 1;

FIG. 4 is a perspective view of an internal tube of the grill shown in FIG. 1;

FIG. 5 is an enlarged partial cross-sectional view of the grill shown in

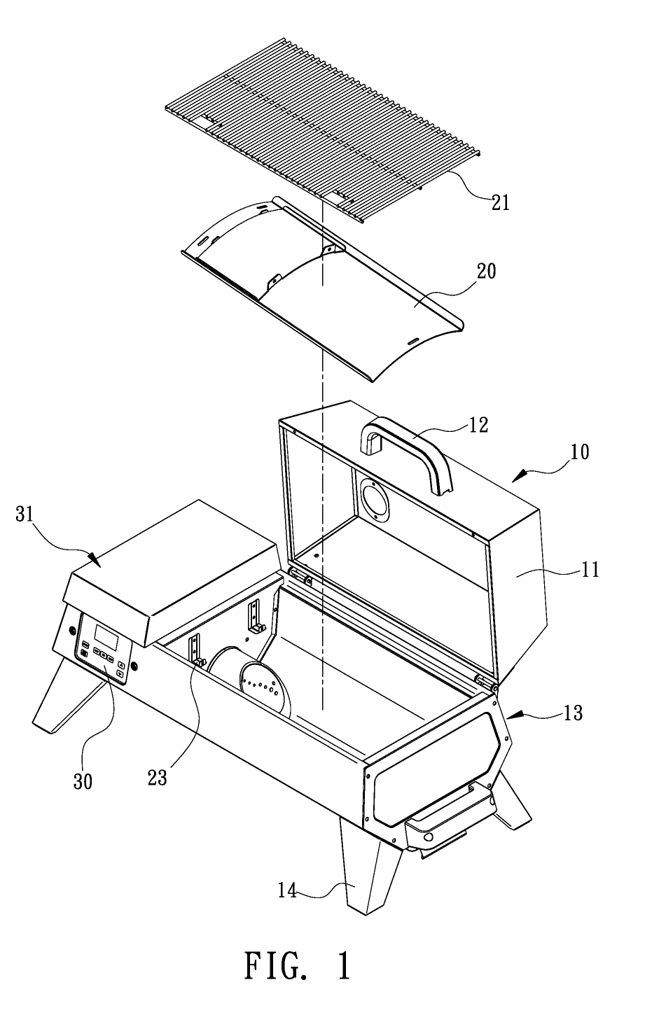

FIG. 1; and

FIG. 6 is another enlarged partial cross-sectional view of the grill shown in FIG. 1.

### DETAILED DESCRIPTION OF PREFERRED EMBODIMENT

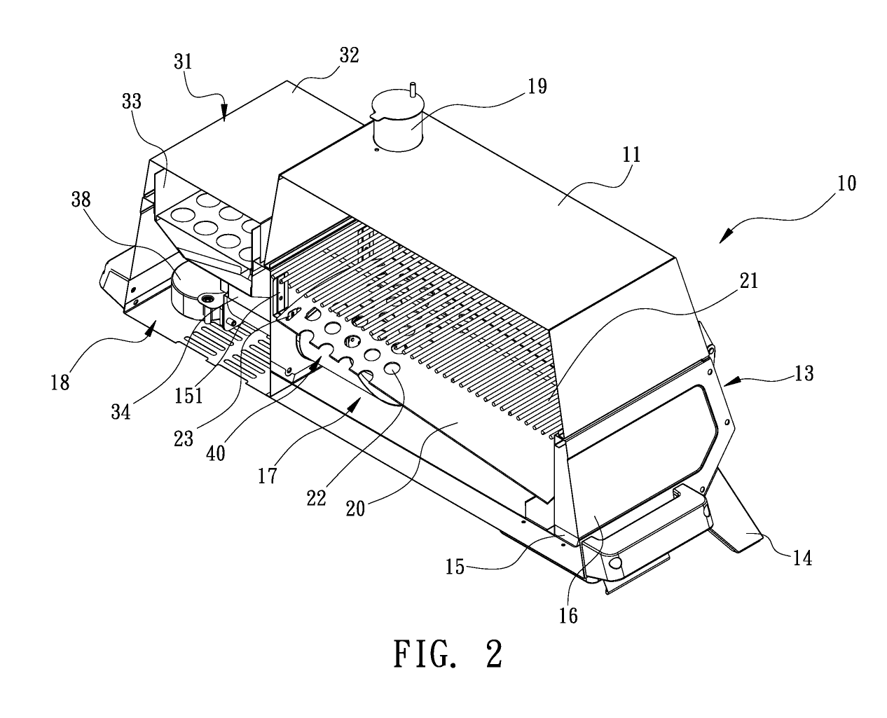

Referring to FIGS. 1 to 3, a grill 10 includes a stove 13, a heat transfer unit, a control unit 30, a feeder assembly 31 and a burner assembly 40 according to the preferred embodiment of the present invention. The stove 13 includes a shell 16 and partitions 15. The shell 16 includes peripheral plates (not numbered) connected to one another and supported on a bottom plate (not numbered). The partitions 15 are located in the shell 16 so that the partitions 15 divide the shell 16 into a combustion chamber 17, an operation chamber 18 and insulating spaces (not numbered). At least one of the insulating spaces is located around the combustion chamber 17. At least one of the insulating spaces is located around the operation chamber 18. Thus, the shell 16 is kept from heat produced by combustion of wood pellets in the combustion chamber 17. Hooks 151 are formed on the partitions 15 for reasons to be given. Four struts 14 are attached to a lower face of the shell 16. In use, grill 10 is supported on a floor via struts 14.

The combustion chamber 17 of the shell 16 is substantially rectangular in a top view. A cover 11 is made in compliance with the combustion chamber 17. The cover 11 includes an edge pivotally connected to an edge of the shell 16 near the combustion chamber 17. A handle 12 is attached to an opposite edge of the cover 11. The handle 12 is operable to pivot the cover 11 up or down to open or close the combustion chamber 17. A chimney 19 is connected to the cover 11. Smoke can be expelled from the combustion chamber 17 via chimney 19 when the combustion chamber 17 is covered by the cover 11.

The heat transfer unit includes a heat-distributing plate 20 and a grid 21. The heat-distributing plate 20 includes apertures 22 and slots 23. The apertures 22 are evenly located closer to an end of the heat-distributing plate 20 than an opposite edge of the same. The slots 23 are located near the edges of the heat-distributing plate 20.

The heat-distributing plate 20 is inserted in the combustion chamber 17 in a slant manner. The hooks 151 are inserted in the slots 23, thereby keeping heat-distributing plate 20 in position in the combustion chamber 17. The apertures 22 are located near one of the partitions 15 that is located between the combustion chamber 17 and the operation chamber 18. The grid 21 is inserted in the combustion chamber 17. The grid 21 is located above the heat-distributing plate 20. In use, food is supported on grid 21.

The control unit 30 preferably includes a touch panel electrically connected to a circuit board (not shown) via wires (not shown). The control unit 30 shows functional data of the grill 10 and is operable to set and change parameters about the operation of the grill 10. However, the control unit 30 can include a conventional liquid crystal display and conventional buttons instead of a touch panel.

Feeder assembly 31 includes a lid 32, a pellet-storing tank 33 and a feeder 34. The pellet-storing tank 33, which is used to store wood pellets, is preferably in the form of a funnel. A lower portion of the pellet-storing tank 33 is inserted in the operation chamber 18 so that the pellet-storing tank 33 covers the operation chamber 18. The lid 32 is used to cover an upper opening of the pellet-storing tank 33 to keep wood pellets in the pellet-storing tank 33 from water for example.

The feeder 34 includes a tube (not numbered), a screw (not numbered) and a motor 35. The feeder 34 is inserted in the operation chamber 18. The tube of the feeder 34 includes a section inserted in the combustion chamber 17 and another section inserted in the operation chamber 18. The pellet-storing tank 33 is in communication of wood pellets with the combustion chamber 17 via tube of the feeder 34. The screw of the feeder 34 is inserted in the tube of the same. The motor 35 is connected to the screw of the feeder 34. The motor 35 is electrically connected to the control unit 30 via wires 36. The control unit 30 is operable to actuate the motor 35 to rotate the screw of the feeder 34 to convey wood pellets into the combustion chamber 17 from the pellet-storing tank 33 via tube of the feeder 34.

A blower 38 is inserted in the operation chamber 18. The blower 38 is electrically connected to the control unit 30. Thus, the control unit 30 is operable to actuate the blower 38 to send air into the operation chamber 18 from the exterior of the shell 16 via bores (not numbered) made in the bottom plate of the shell 16 and further send the air into the combustion chamber 17 from the operation chamber 18. The air propelled by the blower 38 helps the combustion in the combustion chamber 17. Moreover, the air propelled by the blower 38 carries heat from the operation chamber 18, and this is important because the heat would otherwise damage the control unit 30 and/or cause pellets to burn in the pellet-storing tank 33.

The burner assembly 40 is inserted in the combustion chamber 17 so that the burner assembly 40 is located below the apertures 22 of the heat-distributing plate 20.

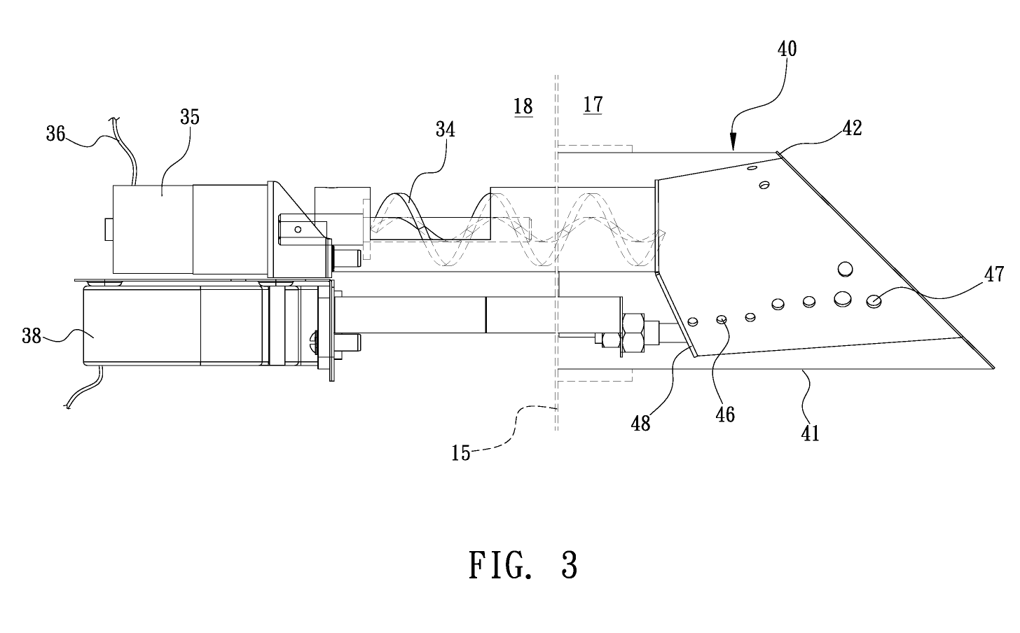

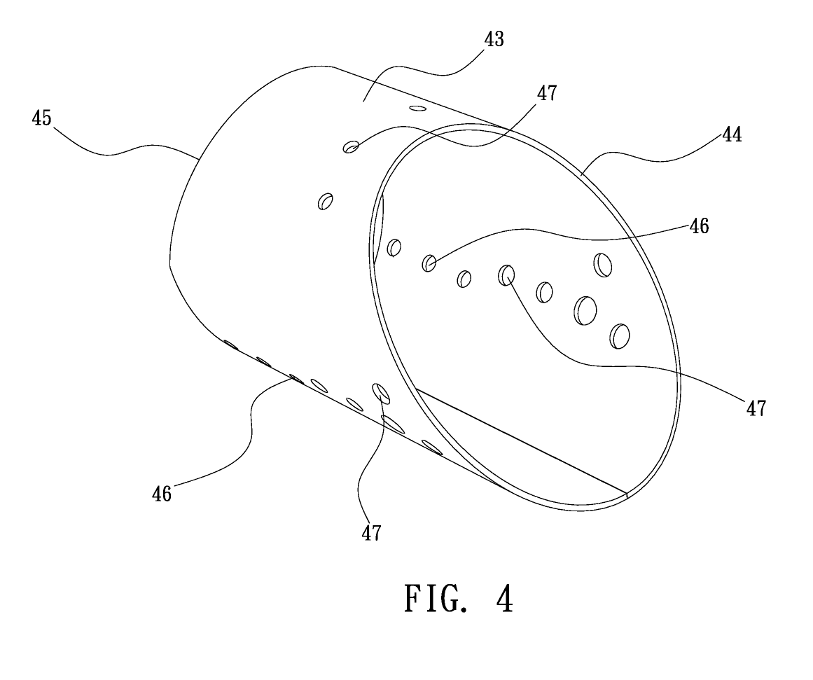

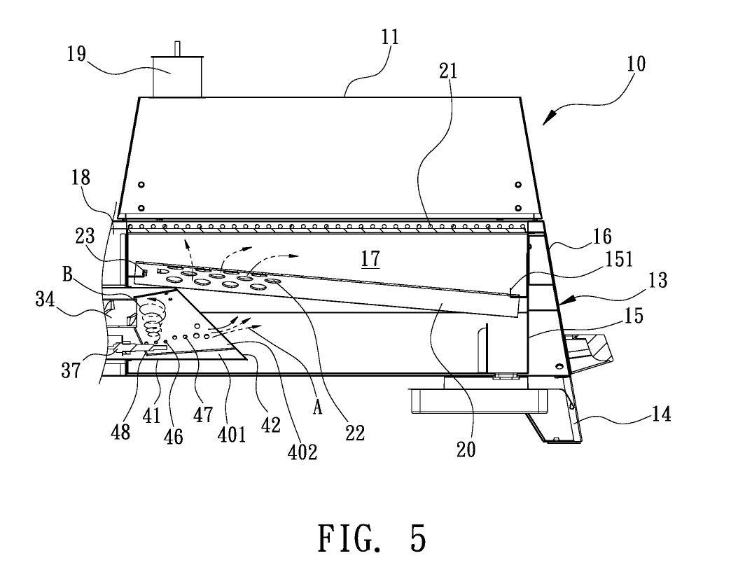

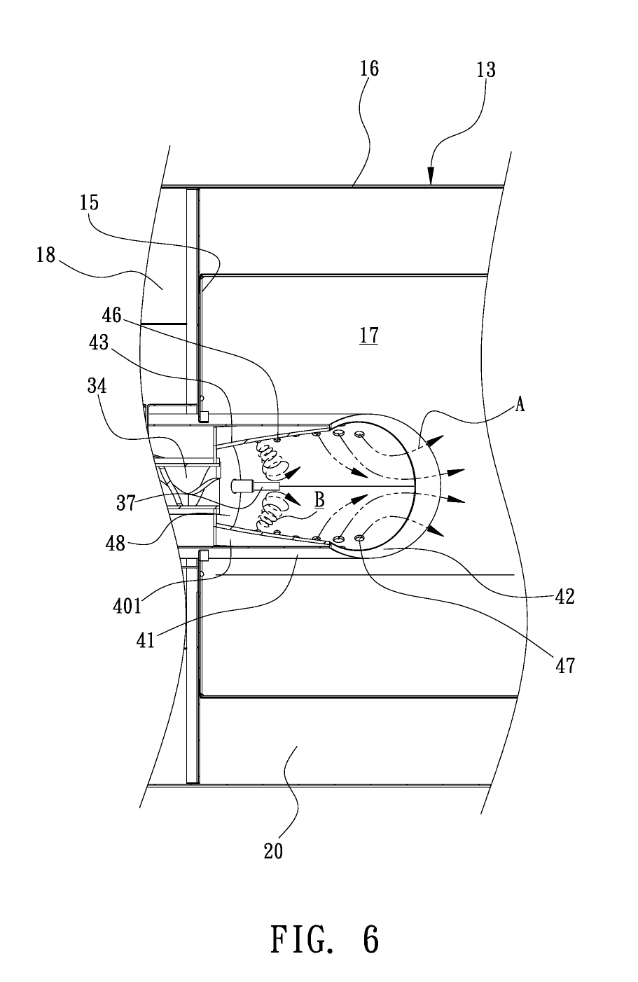

Referring to FIGS. 3 to 6, the burner assembly 40 includes an external tube 41, a front panel 42, an internal tube 43 and a rear panel 48. The external tube 41 is located in the combustion chamber 17. An end of the external tube 41 is connected to the partition 15 that is located between the combustion chamber 17 and the operation chamber 18 by welding or any other proper means. The section of the tube of the feeder 34 that is inserted in the combustion chamber 17 is inserted in the external tube 41 so that the air expelled by the blower 38 goes into the external tube 41.

The internal tube 43 includes a front open end 44, a rear open end 45, a first group of orifices 46 and a second group of orifices 47.

The front panel 42 includes an opening (not numbered) corresponding to the front open end 44 of the internal tube 43.

The rear panel 48 includes an opening (not numbered) corresponding to the rear open end 45 of the internal tube 43.

The internal tube 43 is inserted in the external tube 41. The front panel 42 is connected to another end (the “free end”) of the external tube 41 and the front open end 44 of the internal tube 43. Thus, the front panel 42 supports the internal tube 43 in the external tube 41. Moreover, a first air chamber 401 is defined by the front panel 42, the external tube 41 and the internal tube 43. A portion of the rear open end 45 of the internal tube 43 is covered by the rear panel 48. Thus, a second air chamber 402 is defined by the internal tube 43 and the rear panel 48. The second air chamber 402 is in communication with the front open end 44 of the internal tube 43. Thus, the second air chamber 402 is in communication with the combustion chamber 17 via the front open end 44. The rear panel 48 separates the first air chamber 401 from the second air chamber 402.

As mentioned above, the front panel 42 is connected to the front open end 44 of the internal tube 43 and the free end of the external tube 41. The front panel 42 is an annular element that does not cover the front open end 44 of the internal tube 43. The free end of the external tube 41 and the front open end 44 of the internal tube 43 are slant, i.e., the front panel 42 is slant relative to an axis of the external tube 41. The apertures 22 of the heat-distributing plate 20 are located right above front panel 42.

Furthermore, the first group of orifices 46 is located closer to the rear panel 48 than the second group of orifices 47. The first air chamber 401 is in communication with the second air chamber 402 via the first group of orifices 46 and the second group of orifices 47. When cool air is sent into the first air chamber 401 by the blower 38, some of the cool air enters the second air chamber 402 via the second group of orifices 47 as indicated by an arrow head A, thereby providing a high-temperature combustion region. Synchronously, the other cool air enters the second air chamber 402 through the first group of orifices 46 as indicated by an arrow head B, thereby providing a low-temperature combustion region.

An igniter 37 is used to start the combustion of the wood pellets in the air. The igniter 37 is inserted in the internal tube 43. The igniter 37 is a direct-current igniter. The igniter 37 is connected to the partition 15 that is located between the combustion chamber 17 and the operation chamber 18 and extends into the high-temperature combustion region through the rear panel 48 and the low-temperature combustion region. Thus, the igniter 37 can produce a spark to initiate a flame in the high-temperature combustion region. The flame includes a flame cone, an internal flame and an external flame. The temperature of the flame cone is lower than the internal flame, and the temperature of the internal flame is lower than the external flame.

The low-temperature combustion region is located in the place where the feeder 34 passes the rear panel 48. The wood pellets conveyed by the feeder 34 enter the internal tube 43 through the low-temperature combustion region. The flame cone is located in the low-temperature combustion region to avoid travel of the flame in an inverted sense of direction. Thus, the control unit 30, the motor 35 and the wires 36 are protected from the heat produced by the burner assembly 40.

Moreover, the external flame is located in the high-temperature combustion region where the combustion is rendered efficient by the air that enters the high-temperature combustion region via the second group of orifices 47. The flame extends in a sense of direction as indicated by the arrow head A. Hence, most of the heat produced by the combustion reaches the food supported on the grid 21 through the apertures 22 of the heat-distributing plate 20.

The present invention has been described via illustration of the preferred embodiment. Those skilled in the art can derive variations from the preferred embodiment without departing from the scope of the present invention. Therefore, the preferred embodiment shall not limit the scope of the present invention defined in the claims.

1. A grill-used burner assembly comprising
an external tube comprising a free end;
an internal tube inserted in the external tube and comprising a front open end, a rear open end, a first group of orifices and a second group of orifices;
a front panel connected to the free end of the external tube and the front open end of the internal tube, thereby providing a first air chamber between the external and internal tubes; and
a rear panel connected to the rear open end of the internal tube, thereby providing, in the internal tube, a second air chamber in communication with the front open end of the internal tube, wherein the first air chamber is in communication with the second air chamber via the first and second groups of orifices, and the first group of orifices is located closer to the rear panel than the second group of orifices.

2. The burner assembly according to claim 1, wherein the front panel does not cover the front open end of the internal tube.

3. The burner assembly according to claim 2, wherein the free end of the external tube and the front open end of the internal tube are slant relative to an axis of the external tube, and so is the front panel.

4. A grill comprising:
a stove comprising a combustion chamber; and
a burner assembly set forth in claim 1, wherein the external tube is inserted in the stove, thereby rendering the second air chamber of the internal tube in communication with the combustion chamber via the front open end; and
a blower inserted in the stove, out of the combustion chamber, wherein the blower is adapted for propelling cool air into the first air chamber, some of the air propelled by the blower reaches the second air chamber via the first group of orifices to provide a low-temperature combustion region while the remaining portion of the air propelled by the blower reaches the second air chamber via the second group of orifices to provide a high-temperature combustion region.

5. The grill according to claim 4, further comprising a feeder extending through the rear panel in the stove, wherein the feeder is adapted for conveying wood pellets into the internal tube through the low-temperature combustion region.

6. The grill according to claim 5, further comprising an igniter inserted in the internal tube.

7. The grill according to claim 6, wherein the igniter extending into the high-temperature combustion region through the low-temperature combustion region.

8. The grill according to claim 4, wherein the stove comprises a shell and partitions inserted in the shell so that the partitions divide the interior of the shell into a combustion chamber, an operation chamber near the combustion chamber, and insulating spaces around the combustion chamber, wherein the blower, the feeder and the external tube are inserted in the operation chamber.

9. The grill according to claim 8, further comprising a heat-distributing plate supported on the partitions and inserted in the combustion chamber, wherein the heat-distributing plate shields the burner assembly.

10. The grill according to claim 9, wherein the heat-distributing plate comprises apertures located above the burner assembly.

11. The grill according to claim 9, further comprising hooks attached to the partitions and adapted for hooking the heat-distributing plate.
